(19) United States
(12) Patent Application Publication
(10) Pub. No.: US 2006/0036894 A1
(43) Pub. Date: Feb. 16, 2006

(54) Cluster resource license

(75) Inventors: Theodore W. Bauer, Rochester, MN (US); Jay Symmes Bryant, Rochester, MN (US); Richard Dean Dettinger, Rochester, MN (US); Daniel Paul Kolz, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/901,595

(22) Filed: Jul. 29, 2004

(51) Int. Cl. G06F 11/00

(52) U.S. Cl. 714/4

(57) ABSTRACT

A method, apparatus, system, and signal-bearing medium that, in an embodiment, receive a license to a number of resources in a cluster. The licensed resources may be activated and deactivated at any computer system in the cluster, so long as the number of active resources in the cluster is less than or equal to the number of licensed resources to the cluster. In this way, if a resource or a computer system containing resources in the cluster fails, the licensee may still use other licensed resources up to the number of licensed resources.

### FIELD

An embodiment of the invention generally relates to a cluster of computers. In particular, an embodiment of the invention generally relates to the management of licensed resources on a per-cluster basis.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware components (such as semiconductors, integrated circuits, programmable logic devices, programmable gate arrays, power supplies, electronic card assemblies, sheet metal, cables, and connectors) and software, also known as computer programs. Years ago, computers were isolated devices that did not communicate with each other. But, today computers are often connected in networks, and a user at one computer, often called a client, may wish to access information at multiple other computers, often called servers, via a network.

Clients often wish to send requests or messages to applications that are distributed across multiple servers. A group of multiple servers is often referred to as a cluster. The clusters of servers are used to insure that the applications running on the servers have high availability to the client requests. In the event that one of the servers goes down or experiences some sort of failure or bottleneck, the workload from that server can be transferred to other servers within the cluster. Unfortunately, if the entire cluster is heavily loaded at the time of a server failure, the total processing capacity of the cluster may not be sufficient to meet the processing demands placed upon the cluster's current configuration.

In an attempt to obviate this problem, customers sometimes buy more servers than they expect to need, in order to have backup processing capacity in the event of a failure at one of the servers. Of course, buying extra servers is expensive and wasteful if the backup servers are not needed. In an attempt to find a less expensive technique, customers will sometimes buy a server with multiple processors, only some of which are licensed for use. If the unlicensed processors are needed in the future, the customer may buy an additional license for the processors that are already installed in the server, but not originally in use. This technique is more convenient and faster for the customer because the additionally licensed processors are already installed and can often be activated programmatically. Unfortunately, if a server fails, the customer must spend additional money to license additional processors on another server, despite the fact that the customer has already spent money to license processors that cannot be used on the failing server.

Thus, without a better way to manage the processors in a cluster, customers will continue to suffer extra costs when attempting to attain high availability of service. Although the aforementioned problems have been described in the context of processors, they may occur for any limited resource, such as memory, queues, software instances, data structures, secondary storage, IOAs (Input/Output Adapters), IOPs (Input/Output Processors), network bandwidth, or network adapters. Further, while the aforementioned problems have been described in the context of servers, they may occur in the context of a cluster of any type of computer system or electronic device.

### SUMMARY

A method, apparatus, system, and signal-bearing medium are provided that, in an embodiment, receive a license to a number of resources in a cluster. The licensed resources may be activated and deactivated at any computer system in the cluster, so long as the number of active resources in the cluster is less than or equal to the number of licensed resources to the cluster. In this way, if a resource or a computer system containing resources in the cluster fails, the licensee may still use other licensed resources up to the number of licensed resources.

### BRIEF DESCRIPTION OF THE DRAWING

FIG. 1 depicts a block diagram of an example system for implementing an embodiment of the invention.

FIG. 2 depicts a block diagram of an example configuration of a cluster of computer systems, according to an embodiment of the invention.

FIG. 3 depicts a block diagram of an example data structure for cluster process status, according to an embodiment of the invention.

FIG. 4 depicts a flowchart of example logic for receiving a license, according to an embodiment of the invention.

FIG. 5 depicts a flowchart of example logic for responding to a failure by a cluster manager, according to an embodiment of the invention.

### DETAILED DESCRIPTION

In an embodiment, a cluster of computer systems has active resources, inactive resources, and a license to a maximum number of the resources that may be active at any one time. A cluster manager of the cluster may request activation and deactivation of the resources, so long as the total number of active resources in the cluster is less than or equal to the licensed maximum number of resources. Thus, for example, if a computer system containing a resource fails, or a resource is deactivated, the cluster manager may activate another resource in the cluster, so long as the total number of active resources in the cluster is less than or equal to the licensed maximum number of resources for the cluster.

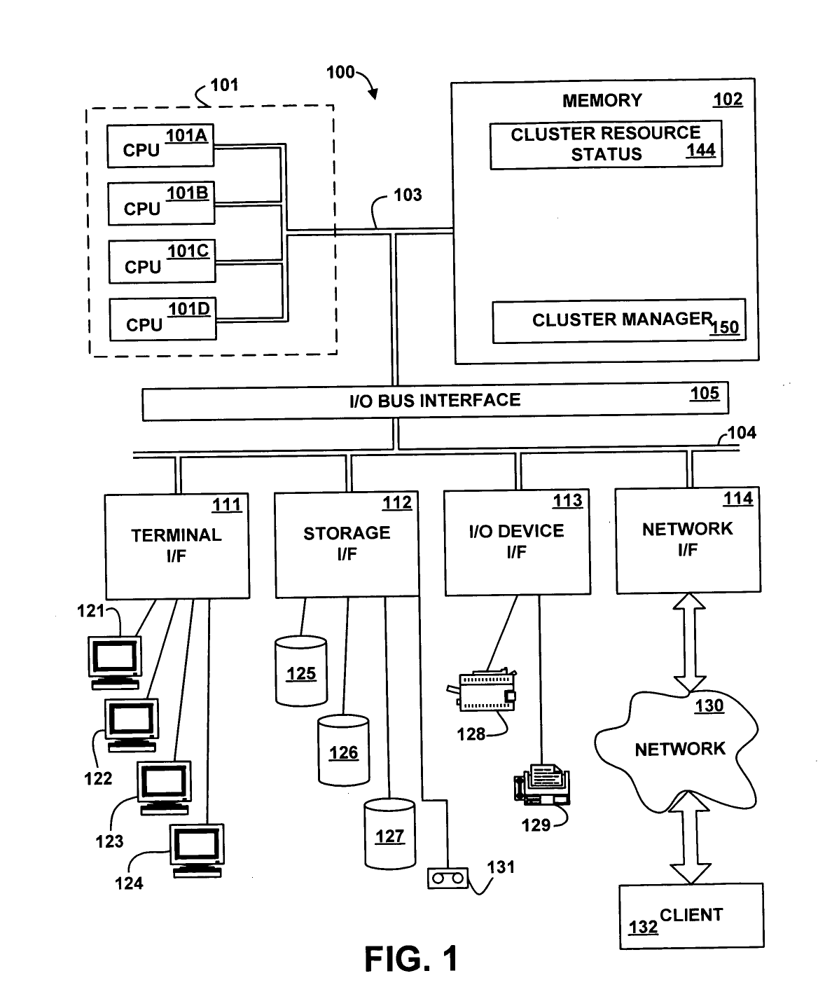

Referring to the Drawing, wherein like numbers denote like parts throughout the several views, FIG. 1 depicts a high-level block diagram representation of a computer system 100 connected to clients 132 via a network 130, according to an embodiment of the present invention. The major components of the computer system 100 include one or more processors 101, main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

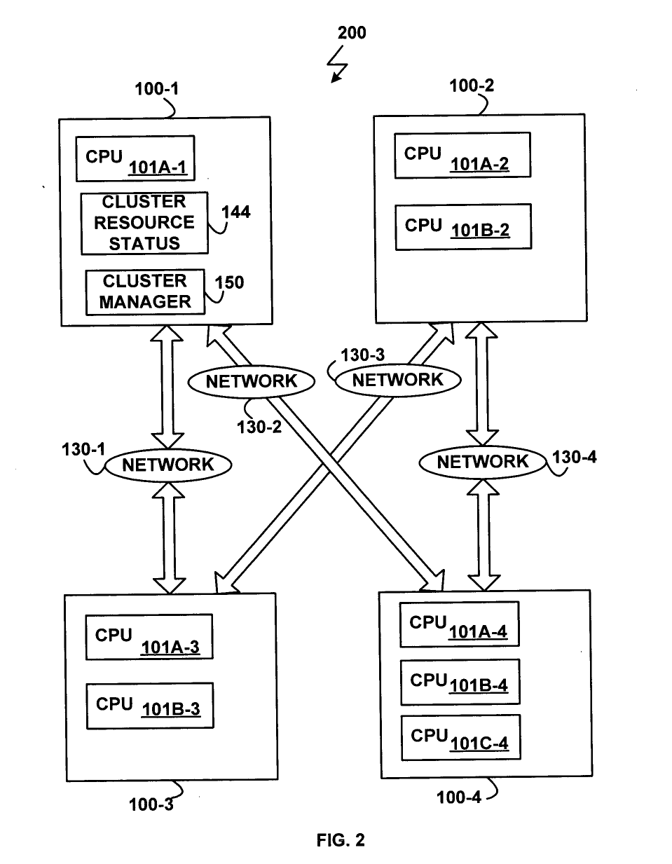

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment, the computer system 100 may alternatively be a single CPU system. Each processor 101 executes instructions stored in the main memory 102 and may include one or more levels of on-board cache. Some or all of the processors 101 may be active or inactive, as further described below with reference to FIGS. 2, 3, 4, and 5.

The main memory 102 is a random-access semiconductor memory for storing data and programs. The main memory 102 is conceptually a single monolithic entity, but in other embodiments, the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 includes cluster resource status 144 and a cluster manager 150. Although the cluster resource status 144 and the cluster manager 150 are illustrated as being contained within the memory 102 in the computer system 100, in other embodiments, some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the cluster resource status 144 and the cluster manager 150 are both illustrated as being contained within the memory 102 in the computer system 100, these elements are not necessarily all completely contained in the same storage device at the same time.

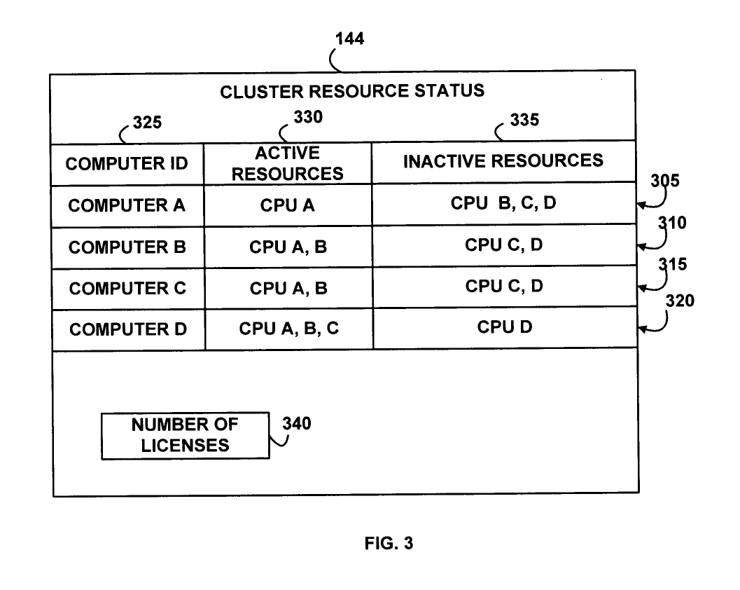

The cluster resource status 144 includes the status of licensable resources, such as the processors 101, whether active or inactive, at the computer system 100 in a cluster. But, in other embodiments, any appropriate resource may be licensed to the cluster, such as memory, queues, queues, software instances, data structures, secondary storage, IOAs or IOPs, network bandwidth across the network, network adapters, or any other appropriate licensable resource. The cluster is further described below with reference to FIG. 2. The cluster resource status 144 is further described below with reference to FIG. 3.

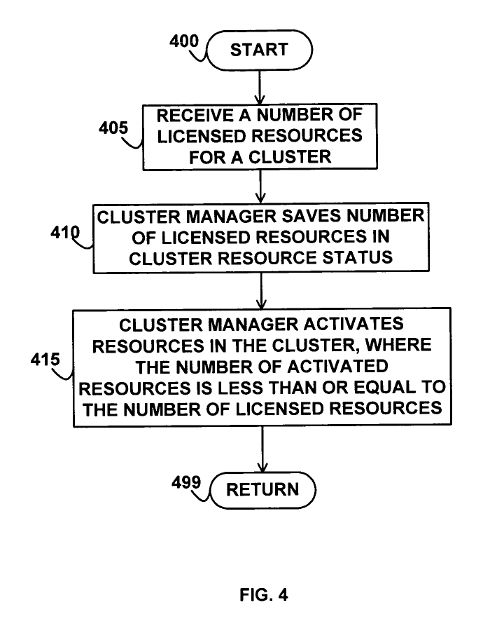

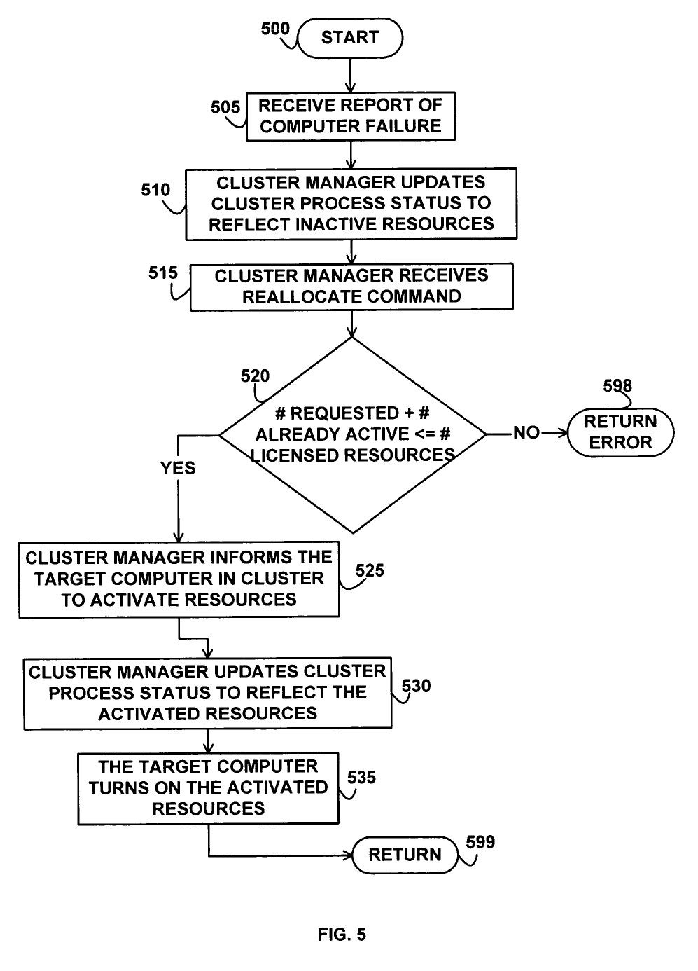

The cluster manager 150 manages the status of licensable resources via the cluster resource status 144, as further described below with reference to FIGS. 2, 3, 4, and 5. In an embodiment, the cluster manager 150 includes instructions capable of executing on the processor 101 or statements capable of being interpreted by instructions executing on the processor 101 to perform the functions as further described below with reference to FIGS. 4 and 5. In another embodiment, the cluster manager 150 may be implemented in microcode. In yet another embodiment, the cluster manager 150 may be implemented in hardware via logic gates and/or other appropriate hardware techniques, in lieu of or in addition to a processor-based system.

The memory bus 103 provides a data communication path for transferring data among the processors 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology. The I/O interface units support communication with a variety of storage and I/O devices. For example, the terminal interface unit 111 supports the attachment of one or more user terminals 121, 122, 123, and 124.

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the DASD 125, 126, and 127 may be loaded from and stored to the memory 102 as needed. The storage interface unit 112 may also support other types of devices, such as a tape device 131, an optical device, or any other type of storage device.

The I/O and other device interface 113 provides an interface to any of various other input/output devices or devices of other types. Two such devices, the printer 128 and the fax machine 129, are shown in the exemplary embodiment of FIG. 1, but in other embodiments, many other such devices may exist, which may be of differing types.

The network interface 114 provides one or more communications paths from the computer system 100 to other digital devices and computer systems, e.g., the client 132; such paths may include, e.g., one or more networks 130. In various embodiments, the network interface 114 may be implemented via a modem, a LAN (Local Area Network) card, a virtual LAN card, or any other appropriate network interface or combination of network interfaces.

Although the memory bus 103 is shown in FIG. 1 as a relatively simple, single bus structure providing a direct communication path among the processors 101, the main memory 102, and the I/O bus interface 105, in fact, the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments, some or all of the I/O devices are connected directly to one or more system I/O buses.

The computer system 100, depicted in FIG. 1, has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a firewall, router, Internet Service Provider (ISP), personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In an embodiment, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line, cable, or bus. In another embodiment, the network 130 may support the Ethernet IEEE (Institute of Electrical and Electronics Engineers) 802.3x specification.

In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 may further include some or all of the hardware components previously described above for the computer system 100. Although only one client 132 is illustrated, in other embodiments any number of clients may be present.

It should be understood that FIG. 1 is intended to depict the representative major components of the computer system 100, the network 130, and the clients 132 at a high level, that individual components may have greater complexity than represented in FIG. 1, that components other than, fewer than, or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements embodying the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 125, 126, or 127), CD-RW, or diskette; or
(3) information conveyed to the computer system 100 by a communications medium, such as through a computer or a telephone network, e.g., the network 130, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example configuration of a cluster 200 of computer systems 100-1, 100-2, 100-3, and 100-4, connected by various networks 130-1, 130-2, and 130-3, and 130-4. The networks 130-1, 130-2, 130-3, and 130-4 are referred to generically in FIG. 1 as the network 130. Although the networks 130-1, 130-2, 130-3, and 103-4 are illustrated as being separate, in another embodiment some or all of them may be the same network. The computer systems 100-1, 100-2, 100-3, and 100-4 are referred to generically in FIG. 1 as the computer system 100.

In the illustrated example, the computer system 100-1 has one active processor, the CPU 101A-1; the computer system 100-2 has two active processors, the CPU 101A-2 and the CPU 101B-2; the computer system 100-3 has two active processors, the CPU 110A-3 and the CPU 10B-3; and the computer system 100-4 has three active processors, the CPU 101A-4, the CPU 101B-4, and the CPU 101C-4. Although the computer systems 100-1, 100-2, 100-3, and 100-4 may have additional, currently inactive, processors, only the active processors are illustrated in FIG. 2.

The CPUs 101A-1, 101A-2, 101B-2, 101A-3, 101B-3, 101A-4, 101B-4, and 101C-4 are examples of resources that are licensed to the cluster 200. But, in other embodiments, any appropriate resource may be licensed to the cluster 200, such as the memory 102, queues, queues, software instances, data structures, secondary storage (e.g., the DASD 125, 126, 127, or the tape 131), IOAs or IOPs (e.g., the terminal interface 111, the storage interface 112, or the I/O device interface 113), network bandwidth across the network 130, network adapters (e.g., the network interface 114), or any other appropriate licensable resource.

Although the cluster resource status 144 and the cluster manager 150 are only illustrated as being contained in the computer system 100-1, in other embodiments they may be distributed across multiple or all of the computer systems 100-1, 100-2, 100-3, and 100-4.

FIG. 3 depicts a block diagram of an example data structure for the cluster resource status 144, according to an embodiment of the invention. The cluster resource status 144 includes records 305, 310, 315, and 320, but in other embodiments any number of records with any appropriate data may be present. Each of the records 305, 310, 315, and 320 includes a computer identifier field 325, an active resources field 330, and an inactive resources field 335, but in other embodiments more or fewer fields may be present.

The computer identifier field 325 identifies the computer system 100 in the cluster 200, e.g., the computer system 100-1, 100-2, 100-3, or 100-4. The active resources field 330 identifies the resources that are active at the computer system 100 associated with the respective record and licensed for use to the cluster 200. The inactive resources field 335 indicates the resources that are inactive at the computer system 100 associated with the respective record and unlicensed for use to the cluster 200. Although the active resources field 330 and the inactive resources field 335 illustrate CPUs 101 as resources, in other embodiments the resources may be any appropriate resource, such as those previously described above with reference to FIG. 2.

The cluster resource status 144 further includes a number of licenses field 340. In another embodiment, the number of licenses field 340 is separate from the cluster resource status 144. The number of licenses field 340 indicates the maximum number of licensed resources available to the cluster 200, regardless of on which computer system 100 the licensed resources reside or are associated with. In another embodiment, the number of licenses field 340 may include separate numbers of licenses for different types of resources.

FIG. 4 depicts a flowchart of example logic for receiving a license, according to an embodiment of the invention. Control begins at block 400. Control then continues to block 405 where the cluster manager 150 receives a license to a number of resources in the cluster 200. The resources may be activated at any computer system(s) in the cluster 200. The cluster manager 150 may receive the license via the network 130 or via a command from a system administrator. The license may originate, e.g., from a manufacturer of the computer system 100 or from a licensor of the associated resources.

Control then continues to block 410 where the cluster manager 150 saves the number of licensed resources in the number of licenses 340 in the cluster resource status 144. Control then continues to block 415 where the cluster manager 150 activates licensed resources at any computer or computers in the cluster 200, where the number of activated resources is less than or equal to the number of licensed resources. Activation means that the resources are capable of being used. The cluster manager 150 further updates the cluster resource status 144, e.g., the records 305, 310, 315, and 320, to reflect the licensed resources that were activated. Control then continues to block 499 where the logic of FIG. 4 returns.

FIG. 5 depicts a flowchart of example logic for the cluster manager 150, according to an embodiment of the invention. Control begins at block 500. Control then continues to block 505 where the cluster manager 150 receives a report of a failure of one of the computer systems 100. In another embodiment, the cluster manager 150 receives a report of a failure of one or more of the resources. The report may originate programmatically from one of the computer systems 100, from a system administrator, or from any other appropriate source, internal or external to the cluster 200.

Control then continues to block 510 where the cluster manager 150 updates the cluster resource status 144 to reflect the inactive resources at the computer system 100 that failed. For example, if the computer system denoted as “Computer A” in the computer identifier field 325 fails, then the cluster manager 150 updates the active resources field 330 in the record 305 to remove “CPU A” since it is no longer active. Then, the cluster manager 150 adds “CPU A” to the inactive resources field 335 in the record 305 to reflect that CPU A is no longer active. Thus, the cluster manager 150 deactivates the resource in response to the failure.

Control then continues to block 515 where the cluster manager 150 receives a reallocate command. The allocate command specifies a number of requested resources to be activated and a target computer system at which to activate them. A reallocate command may be received from an administrator of the cluster 200, programmatically, or from any other appropriate source whether internal or external to the cluster 200.

Control then continues to block 520 where the cluster manager 150 determines whether the number of requested resources (specified in the reallocate command received at block 515) plus the number of already active resources in the cluster 200 is less than or equal to the number of licensed resources 340 to the cluster 200. The cluster manager 150 may determine the number of already active resources by summing the number of resources in the active resources field 330 for each record in the cluster resource status 144.

If the determination at block 520 is false, then the number of requested resources plus the number of already active resources in the cluster 200 is greater than the number of licensed resources 340 to the cluster 200, so control continues to block 598 where the cluster manager 150 returns an error to the requester of the reallocate command. The requester receives an error because the reallocate command attempted to activate a number of resources that would have raised the total number of resources active in the cluster 200 greater than the number of resources licensed to the cluster 200.

If the determination at block 520 is true, then number of requested resources plus the number of already active resources in the cluster 200 is less than or equal to the number of licensed resources 340, so control continues to block 525 where the cluster manager 150 instructs the target computer system 100 specified by the reallocate command to activate the specified resource or resources. Neither the cluster manager 150 nor the target computer 100 need to contact the licensor of the resource for authorization or additional licenses because the cluster manager 150 is merely reallocating already licensed resources within the cluster 200.

Control then continues to block 530 where the cluster manager 150 updates the cluster resource status 144 to reflect the activate resources at the target computer system 100. For example, the cluster manager 150 adds the activated resource to the active resources field 330 in the entry associated with the target computer system 100. Control then continues to block 535 where the cluster manager 150 sends an activation request to the target computer system 100, which in response turns on or activates the resources, so that they are available for use. Control then continues to block 599 where the logic of FIG. 5 returns.

In this way, the cluster manager 150 reallocates active licensed resources between computer systems 100 in the cluster 200.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized, and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
receiving a license to a number of resources in a cluster, wherein the number of licensed resources may be activated at any of a plurality of computer systems in the cluster.

2. The method of claim 1, further comprising:
activating at least one of the resources within the cluster if the activating causes a number of active resources in the cluster to be less than or equal to the number of licensed resources in the cluster.

3. The method of claim 1, further comprising:
reallocating at least one of the resources within the cluster in response to a failure of one of the plurality of computer systems in the cluster if the reallocating causes a number of active resources in the cluster to be less than or equal to the number of licensed resources in the cluster.

4. The method of claim 1, further comprising:
reallocating at least one of the resources within the cluster in response to a failure of the at least one of the resources if the reallocating causes a number of active resources in the cluster to be less than or equal to the number of licensed resources in the cluster.

5. An apparatus comprising:
means for receiving a license to a number of resources in a cluster of computer systems, wherein the number of licensed resources may be activated at any of the computer systems in the cluster; and
means for activating a plurality of the resources within the cluster if the activating causes a number of active resources in the cluster to be less than or equal to the number of licensed resources in the cluster.

6. The apparatus of claim 5, further comprising:
means for reallocating at least one of the resources within the cluster in response to a failure of one of the computer systems in the cluster if the reallocating causes the number of active resources in the cluster to be less than or equal to the number of licensed resources in the cluster.

7. The apparatus of claim 5, further comprising:
means for reallocating at least one of the resources within the cluster in response to a failure of the at least one of the resources if the reallocating causes the number of active resources in the cluster to be less than or equal to the number of licensed resources in the cluster.

8. The apparatus of claim 5, further comprising:
means for updating the number of active resources in the cluster in response to failure of one of the active resources.

9. A signal-bearing medium encoded with instructions, wherein the instructions when executed comprise:
deactivating a first licensed resource at a first computer of a plurality of computers in a cluster; and
activating a second licensed resource at a second computer of the plurality of computers if a number of active resources in the cluster is less than or equal to a number of licensed resources to the cluster.

10. The signal-bearing medium of claim 9, wherein the deactivating is in response to a failure of the first licensed resource.

11. The signal-bearing medium of claim 9, wherein the deactivating is in response to a failure of the first computer.

12. The signal-bearing medium of claim 9, wherein the activating is in response to an reallocate command.

13. A computer system comprising:
a processor; and
memory encoded with instructions, wherein the instructions when executed on the processor comprise:
receiving a report of a failure at a first computer in a cluster,
updating cluster status to reflect an inactive licensed resource in response to the report,
determining whether a number of requested licensed resources plus a number of already active licensed resources is less than or equal to a number of licensed resources to the cluster, and
if the determining is true, sending a request for activation of the requested licensed resources to a second computer in the cluster.

14. The computer system of claim 13, wherein the instructions further comprise:
if the determining is false, refraining from activating the requested licensed resources at the second computer in the cluster.

15. The computer system of claim 13, wherein the failure comprises failure of the inactive licensed resource at the first computer.

16. The computer system of claim 13, wherein the failure comprises failure of the first computer.

17. A method for configuring a computer, comprising:
configuring the computer to receive a license to a number of resources in a cluster, wherein the number of licensed resources may be activated at any of a plurality of computer systems in the cluster.

18. The method of claim 17, further comprising:
configuring the computer to activate at least one of the resources within the cluster if the activating causes a number of active resources in the cluster to be less than or equal to the number of licensed resources in the cluster.

19. The method of claim 17, further comprising:
configuring the computer to reallocate at least one of the resources within the cluster in response to a failure of one of the plurality of computer systems in the cluster if the reallocating causes a number of active resources in the cluster to be less than or equal to the number of licensed resources in the cluster.

20. The method of claim 17, further comprising:
configuring the computer to reallocate at least one of the resources within the cluster in response to a failure of the resource if the reallocating causes a number of active resources in the cluster to be less than or equal to the number of licensed resources in the cluster.
